(19) United States
(12) Patent Application Publication
(10) Pub. No.: US 2006/0077302 A1
(43) Pub. Date: Apr. 13, 2006

(54) Comb filter

(75) Inventor: Michael Wouter Nieuwenhuizen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/538,616

(22) PCT Filed: Nov. 14, 2003
(86) PCT No.: PCT/IB03/05159

§ 371 Date: Jun. 10, 2005

(30) Foreign Application Priority Data
Dec. 16, 2002 (EP) 02080313.6

(51) Int. Cl. H04N 9/78

(52) U.S. Cl. 348/665

(57) ABSTRACT

In a method of compensating errors in comb filters in a line-locked sample domain, an input video signal (CVBS) is delayed (LD1, LD2) by first and second integral numbers of lines to obtain first and second delayed signals, a phase difference is measured (PM) between at least two of the input video signal (CVBS) and the first and second delayed signals, and a phase of the input video signal (CVBS) and a phase of the second delayed signal are corrected (PC1, PC2) with respect to the first delayed signal in dependence on the phase difference.

The invention relates to a comb filter.

Many comb filters use a burst-lock clock to sample the video data. This has the intrinsic advantage that the phase relation of the subcarrier between lines and fields is very well defined. Cross luminance suppression can be very good, even under non-standard non-ideal situations. In a line-locked clock system, contrary to burst lock, there are severe problems with non-standard line frequencies, because a deviating line frequency will diminish the cross-luminance suppression. Furthermore a line locked clock can create more jitter in the signal than is to be expected from a well-designed burst lock system. It is therefore necessary to add special measures to the 3D-comb filter.

### THE PROBLEM

Non-Standard Line-Frequencies.

Assume a line-locked sample domain. A video signal in this domain will have a constant number of samples per line, irrespective of the line frequency. Worst case the line frequency can deviate 4% from the nominal frequency, which means (given a constant number of pixels per line) that the sample frequency varies + and −4% as well. The chrominance subcarrier frequency is almost constant, so relative to the sampling grid, the sub-carrier frequency will vary −/+4% as function of the line-frequency.

As an example, let us assume a line frequency that is 0.1% too high. On a line locked grid this gives after sampling a color subcarrier that is 0.1% (4433 Hz) lower than nominal. If we take two points that are exactly one line apart, they will have a subcarrier phase error of 120 degrees. Comparing this with the required 1 . . . 2 degrees accuracy for cross-luminance suppression, it will be clear that a line-locked sample grid can only be combined with a comb filter if special corrective measures are taken.

This problem is mainly of interest for a spatial comb filter, because it is generally accepted that a temporal comb filter is switched off under non-standard conditions.

Jitter

The time constant of the PLL of the horizontal sync regeneration is in general a number of TV lines. This means that between lines that are close together in time, the jitter is negligible, but for lines that are further away in time (e.g. a field or more apart), the PLL will not suppress noise very well and jitter can become larger. For normal TV this is still sufficient, but for a comb filter, the demands are more severe, mainly because the subtraction of two high frequency subcarriers needs a very accurate phase between them. For PALplus an accuracy of 1 ns is used while the performance of a line locked clock is 10 times less accurate.

It is, inter alia, an object of the invention to provide an improved comb filter. To this end, the invention provides a comb filter as defined in the independent claims. Advantageous embodiments are defined in the dependent claims.

In accordance with a preferred aspect of the present invention, the phase of the other lines used in the comb filter is adapted to that of the current line. This relative way of working is well suited to the problem at hand, because the position or phase of the current line is not changed, hence there is no need to shift back after the comb filter, and the (burst key of the) current line functions as the reference signal, so there is no need for a PLL and false-locking is not a problem. A particular advantageous aspect of the invention is formed by correcting a frequency deviation due to a line-locked sampling grid by means of a combination of a phase meter and phase correction.

These and other aspects of the invention will be apparent from and elucidated with reference to the embodiments described hereinafter.

In the drawings:

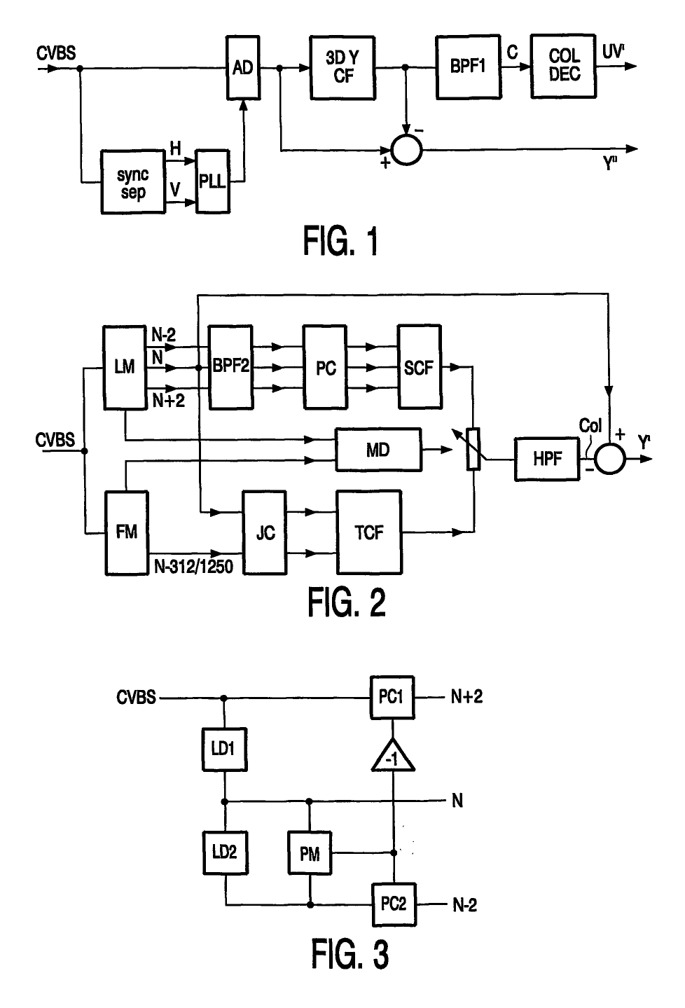

FIG. 1 shows a block diagram of a prior art comb filter;

FIG. 2 shows a block diagram of a 3D luminance comb filter in accordance with the present invention;

FIG. 3 shows a generic block diagram of a phase shift correction in accordance with the present invention;

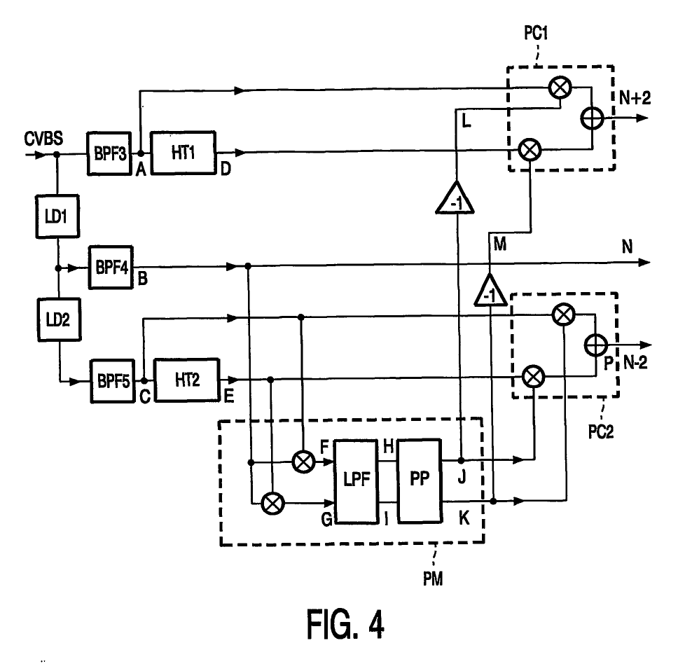

FIG. 4 shows a block diagram of a trigonometric solution of a comb filter in accordance with the present invention;

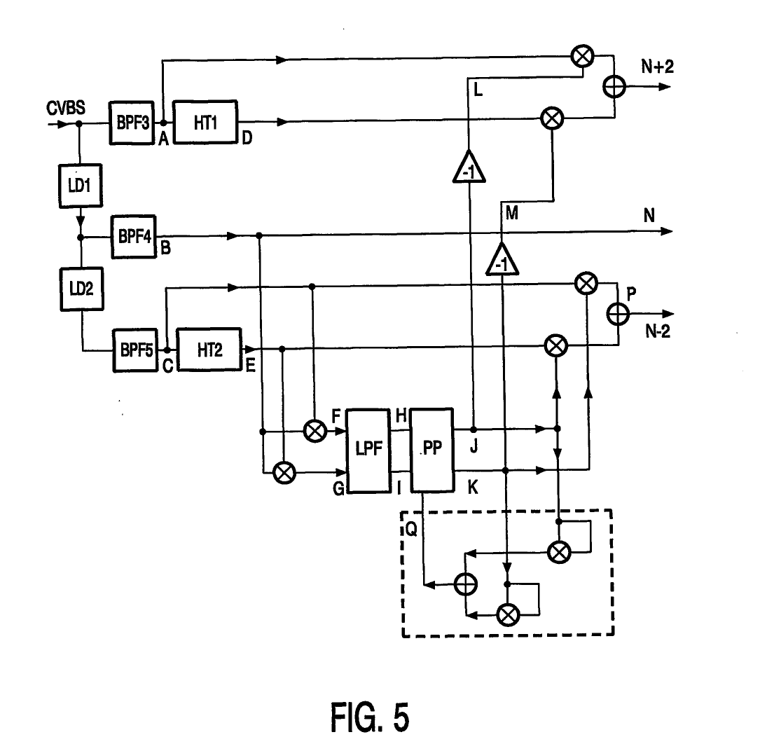

FIG. 5 shows a block diagram of a trigonometric solution with amplitude measurement in accordance with the present invention;

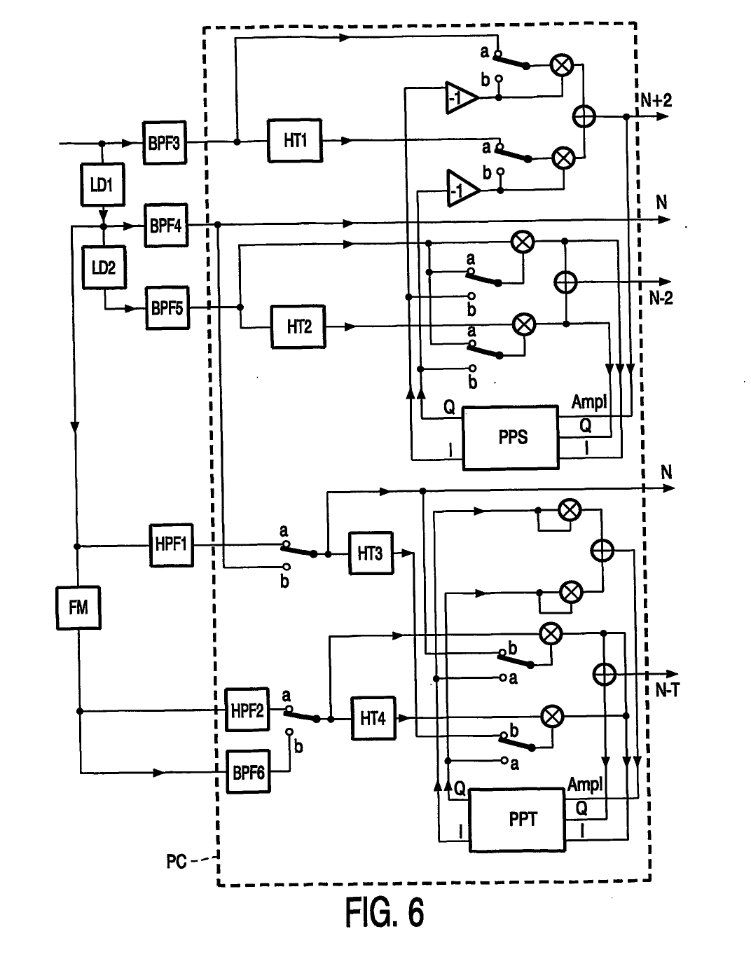

FIG. 6 shows a block diagram of a trigonometric implementation of the phase corrector in accordance with the present invention; and

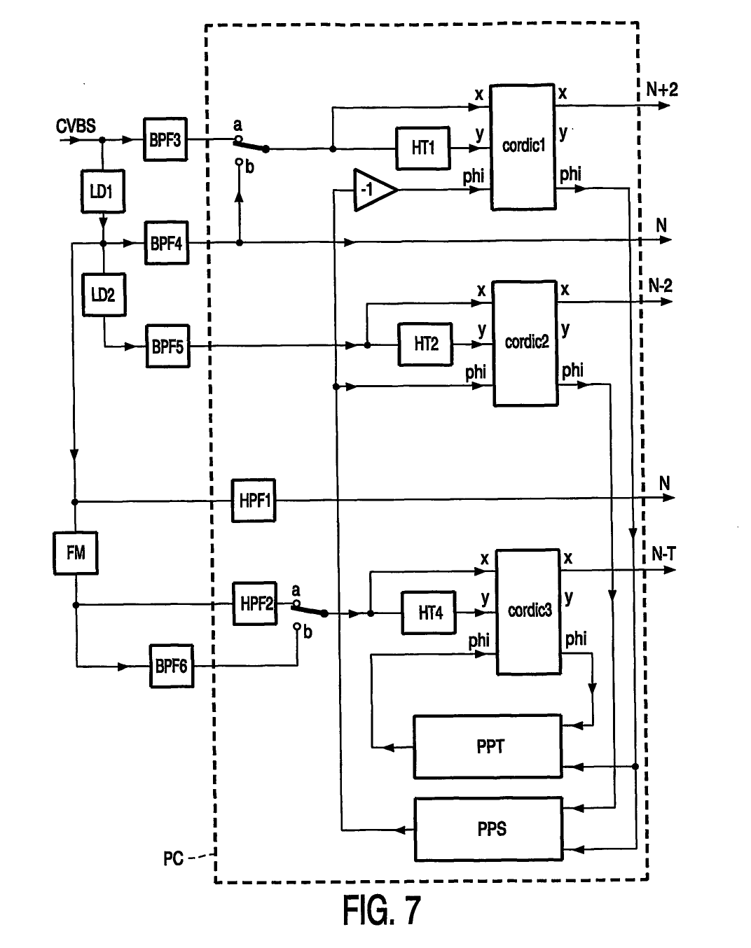

FIG. 7 shows a block diagram of a Cordic implementation of the phase corrector in accordance with the present invention.

FIG. 1 shows a prior art line-locked comb filter. A CVBS input signal is applied to an A/D converter AD2 and thereafter comb filtered by a 3D luminance comb filter 3D Y CF. The comb filter output signal is applied to a band-pass filter BPF1 to furnish a color information signal C to a color decoder COLDEC. The color decoder COLDEC provides a UV signal UV′. The comb filter signal is subtracted from the digitized CVBS signal to form the luminance output signal Y″. The A/D converter AD is clocked by a line-locked clock obtained by a PLL from H and V sync signals provided by a synchronization separator syncsep from the CVBS input signal.

In FIG. 2, the basic structure of the 3D luminance comb filter is given. The 3D-comb filter is a combination of a spatial and a temporal filter. A spatial comb filter uses the current line and lines that are 1 (NTSC) or 2 (PAL) lines above and below the current line in the same field. A temporal comb filter uses the current line and one that is a field, 1 frame (NTSC) or 2 frames (PAL) away in time. A motion detector fades between both outputs depending on the local presence of motion. The band-pass and high-pass filters are optimized for optimal suppression of cross-luminance without loss of sharpness.

The digitized CVBS signal is applied to a line memories block LM to provide the lines N+2, N and N+2 (PAL) or N−1, N, and N+1 (NTSC). In the remainder of this description, only the PAL situation will be described; those skilled in the art can easily adapt this to embodiments suitable for NTSC. These lines are applied to a band-pass filter block BPF2, to a phase correction block PC, and to a spatial comb filter block SCF to provide one input to a fader F. The digitized CVBS signal is also applied to a field/frame memory block FM to provide the line N-312/N-1250. The lines N and N-312/1250 are applied to a jitter correction block JC and then to a temporal comb filter TCF to provide another input of the fader F. The fader F is controlled by a motion detector MD receiving signals from the line memories block LM and the frame/field memory block FM. A fader output is applied to a high-pass filter HPF to obtain a color signal that is subtracted from the line N signal to obtain the comb filtered luminance signal Y′.

First a solution for the non-standard line frequency problem. Later we will see that the method can be applied with minimal changes to the jitter problem as well. It can be calculated that a correction for the non-standard line frequency has to be in the form of a phase shifting that is equal for all sidebands of the subcarrier.

A generic block diagram for the correction of the spatial comb filter is sketched in FIG. 3. The FIG. 3 circuit corresponds to the line memories block LM plus the phase correction block PC in FIG. 2. In FIG. 3, the band-pass filter block BPF2 of FIG. 2 is left out to simplify the explanation. The digitized CVBS signal is applied to first and second line delays LD1, LD2. In a PAL environment, each line delay LD1, LD2 delays by two lines, while in an NTSC environment, each line delay LD1, LD2 delays by one line. The output of line delay LD1 provides the line N signal. A phase meter PM compares the outputs of the line delays LD1 and LD2 to provide a control signal to a phase corrector PC2 coupled to the output of line delay LD2 and providing the line N−2 signal, and after inversion, to a phase corrector PC1 receiving the digitized CVBS signal and providing the line N+2 signal. Note that we only need one phase meter PM, since we expect the phase difference of the line below the current line to be the inverse of that of the line above it. Alternatively, the phase meter inputs may be connected to receive the CVBS input signal and the output of the first line delay LD1, or the CVBS input signal and the output of the second line delay LD2, or all three of the CVBS input signal and the outputs of the first and second line delay LD1, LD2.

Phase Shifter

FIG. 4 shows an embodiment of a trigonometric solution. In comparison with FIG. 3, the following changes are made. Between the CVBS input and the phase corrector PC1 there are a band-pass filter BPF3 and a Hilbert transform block HT1. A band-pass filter BPF4 is placed between the output of the line delay LD1 and the line N output. Between the output of the line delay LD2 and the phase corrector PC2 there are a band-pass filter BPF5 and a Hilbert transform block HT2. Please note that in the embodiment of FIG. 2, the band-pass filter block BPF2 was also placed between the line memories block LM and the phase correction block PC. The phase correctors PC1, PC2 comprise each two multipliers and an adder for summing the multiplier outputs. The phase meter PM comprises a first multiplier for multiplying the outputs of band-pass filters BPF4 and BPF5, a second multiplier for multiplying the outputs of the band-pass filter BPF4 and the Hilbert transform block HT2, a low-pass filter block LPF receiving outputs of the multipliers, and a phase processing block PP receiving outputs of the low-pass filter block LPF to provide control signals to the phase correctors PC1, PC2.

Next we will explain the functionality of the phase shifter, based on standard trigonometry. Let us assume we have the situation of FIG. 4. We assume that the input signal only contains frequencies that are relevant for the comb filter. In a practical comb filter a band-pass filter will precede the phase corrector.

Input signals during burst (only the subcarrier is present)
V_{A}=A. sin(ωt−φ)
V_{B}=A. sin(ωt)
V_{C}=A. sin(ωt+φ)

For the phase meter PM we only use lines B and C. For the phase measurement, we need both inputs plus the 90 degrees phase shifted version of line C. Such a signal can be generated with a Hilbert transform, which is a special form of a FIR filter (see e.g. [1]) that gives a standard phase shift of 90 degrees between input and output. An example of such a filter is [−1, 0, −7, 0, −38, 0, 38, 0, 7, 0, 1]/64. Note that the coefficients are anti-symmetrical. This is one of the basic properties of this type of filter.

Output Hilbert Transform:
V_{E}=A. cos(ωt+φ)
We multiply now V_{C} and V_{E} with V_{B}

$${V}_{F} = \frac{1}{2} {A}^{2} cos ( φ ) - \frac{1}{2} {A}^{2} cos ( 2 ω t + φ )$$

$${V}_{G} = \frac{1}{2} {A}^{2} sin ( φ ) - \frac{1}{2} {A}^{2} sin ( 2 ω t + φ )$$

This signal is low pas filtered and the result averaged over at least one burst period:
V_{H}=A² cos(φ)
V_{I}=A² sin(φ)
The factor A² is disturbing the control function, because it will modulate the output signal of the phase shifter, so we must divide the control signals by this (normally constant) amplitude. Since a real divider is costly, the correction is done by adapting the number of pixels over which we average the phase. This is one of the functions of the “phase processing” block. Another function of it is a sample and hold function: the averaged result of the measurement during the burst is stored and used to correct during the scan. So we get as control signal during active video:
V_{J}=cos(φ)
V_{K}=sin(φ)
During the scan, we multiply the main input signal with the control signals
V_{P}=V_{C}.V_{K}+V_{E}.Y_{J}
V_{P}=A(t)sin(ωt+φ)cos(φ)+A(t)cos(φt+φ)sin(φ)
V_{P}=A(t) sin(φt)
We see that V_{P} is the wanted phase corrected signal for line N+2 as required. For line N+2 we do not have to measure the phase separately, because it is the inverse of that of line N+2. The correction is similar to that of line N+2.
Amplitude Correction

As already mentioned, we need to normalize the phase control signals. For this we use a feed-back system. We measure the amplitude of V_{J} and V_{K}.
V_{Q}=V_{J}²+V_{K}²
Assume that V_{J} and V_{K} have an amplitude error X:
V_{Q}=(X sin(φ}}²+(X cos(φ))²=X²
V_{Q} is used to control the averaging in the phase processing block PP: if it is smaller than 1, we must use more pixels for the averaging, if it is larger than 1 we need less pixels. In this way it is possible to implement the divider in an elegant way without the need for a real divider.

In comparison with FIG. 4, in FIG. 5 this control loop is added: the J and K outputs of phase processing block PP are squared, the squares are summed, and the sum Q is applied to the phase processing block PP. It looks like a difficult way to measure the burst amplitude but as we will see later, it turns out to be cheap because it reuses multipliers that are already available for another task.

Jitter Reduction

The jitter that is introduced during the AD conversion or the sample rate conversion is a time shift. A perfect solution would be a time shift in the opposite direction. However, in this case the time shift is small (fraction of a sample time) and we are only interested in compensating a relatively narrow band of frequencies near the subcarrier. Under these conditions it is allowed to approximate the time shift with a phase shift and hence the same method as described above can be used. The only difference is that in the spatial domain we expect a rather slowly varying phase offset while in the case of jitter removal, the phase can change each line. Hence the averaging time constant might be different.

Practical Implementation

Trigonometric Solution

The formulas presented above can be implemented directly. It is possible to decrease their number of multipliers by time multiplexing them. We use the same multipliers during the burst for measurement as we use during active video for correction. As a result, the number of multipliers for a combination of a temporal and a spatial correction need to be only 8, saving 6. In the block diagram of FIG. 6 such a multiplexed system is sketched. This implementation is a combination of a spatial and a temporal corrector, as is needed for a complete 3D comb filter. The inputs are the present line, its spatial neighbors (one line distance for NTSC, two lines distance for PAL), and a temporal input from 1, 2 or 4 fields previous. So, in FIGS. 6 and 7, the outputs N+2, N, N+2 are applied to a spatial comb filter, while the outputs N and a high-pass filtered signal N-T corresponding to a previous center line are applied to a temporal comb filter (not shown).

The 90 degrees phase shifters needed for generating the sin and cos terms are realized with Hilbert transform filters with coefficients [−1, 0, −7, 0, −38, 0, 38, 0, 7, 0, 1]/64. The phase shift of this filter is exact 90 degrees for all frequencies. Since the amplitude transfer between input and output is less than unity for very low and very high frequencies, it can be used between 1.8 and 5 MHz, which is sufficient for our purpose. The phase measurement and the shifter will only function correctly if the input is bandwidth-limited to frequencies that are correctly shifted by the Hilbert transform. For the spatial filter this is automatically fulfilled by the band-pass filters BPF3-BPF5 that are already in the comb filter. For the temporal filter, there is no such filter in front of it, so we have to add one (HPF2). In fact we have to add two (HPF1, HPF2), because there must also be a filter HPF1 in the main path to keep the dynamic peaking working well. These filters have coefficients [−1, 0, −6, 0, −15, 0, 44, 0, −15, 0, −6, 0, −1]/64. The transfer curve is similar to that of the Hilbert transform, but with linear phase. All multipliers are 10 bit signed*10 bit signed. The output is rounded to 10 bit signed again. The temporal section of the embodiment of FIG. 6 further comprises a field/frame delay FM, Hilbert transform blocks HT3, HT4, and a band-pass filter BPF6. The spatial and temporal phase processing blocks PPS, PPT contain an averaging of the I and Q signals in two stages: each line the average over the burst samples is taken and there is an average over a number of lines, which includes the amplitude normalization of the I and Q signals. The switches are in the “a” positions during active video, and in the “b” positions during the burst periods.

Cordic Realization

There is another way to realize the phase corrector. This uses the Cordic algorithm, which is an iterative algorithm, that can (depending on the mode) either measure the angle of a vector or rotate a vector over an arbitrary angle. A normal iterative algorithm would halve the rotation angle each step (+/−90 degrees in the first step, +/−45 in the second, +/−22.5 in the third etc.). This is very computational intensive because it involves a lot of wide multiplications. The trick of Cordic is that the rotation angles are adapted such that all the multiplications become shifts. The algorithm is used in many floating-point coprocessors (Intel, HP etc.). We use it as phase detector in the SECAM decoder of the Philips Digital Multi Standard Decoder (e.g. SAA7114, SAA7118). There are two basic modes:

1: to rotate any vector over such an angle that the output vector is along the X-axis. By remembering the rotations of each iterative step and adding them together, we know the total rotation, so we know the angle of the input vector. This is the mode we use for measuring.

2: to rotate a vector over an arbitrary angle. This is the mode we use for the correction.

From literature it is known, that Cordic can be implemented in hardware in a very efficient way, even for very high data frequencies. Unrolling the iterative algorithm is than necessary. A good introduction of the algorithm can be found in [2], to which reference is made for a number of examples of possible hardware implementations.

A Cordic based implementation is shown in FIG. 7. Again we use the same hardware during the burst for measuring as we use for correction during active video. The uppermost Cordic circuit cordic1 measures the phase of the center line of the current frame during the burst. It corrects the line below the current center line during active video. The middle Cordic circuit cordic2 measures and corrects the line above the current field. The lower Cordic circuit cordic3 measures and corrects the center line of the previous field.

Note here a basic difference between the two solutions: in the trigonometric solution, the phase difference between lines is directly measured. In case of the Cordic, the absolute phases of two lines are measured separately and the phase difference is calculated by subtracting the two measurements. In case of a combined spatial/temporal corrector, this saves one Cordic, because we can use the phase meter of the present line for both the temporal and the spatial measurement. This means that we must measure the phase of the present line, one of the spatial neighbors (1 or 2 lines away) and the temporal neighbor (1, 2, 4 fields away). Since we need also three Cordics for the correction (both spatial neighbors and the temporal neighbor must be corrected regarding to the present line), this is the most effective implementation using Cordics. To obtain this minimum hardware/software implementation, some switching is needed between the measurement and correction modes.

The temporal and spatial phase processing blocks PPT, PPS contain averaging over the pixels of the burst for each line and an averaging over a selectable number of lines. To allow reliable averaging for all phase differences, including at 180 degrees, an additional correction is applied.

A Cordic implementation is more economical than a trigonometric implementation. Even if a Cordic is twice as complex as a multiplier, it is still attractive to use the Cordic version. Apart from the size there are other advantages: The measured phase is independent of the burst amplitude. No (implicit) divider is needed. Note however that with small burst amplitudes the accuracy of the phase suffers, but so does the need for accuracy since a smaller burst will be less visible anyhow. There is less switching needed to use the hardware efficiently. The measured phase does not contain higher harmonics, so less filtering is needed in the “processing” blocks. 3 instead of 4 Hilbert transforms are needed. All three Cordics are in the same mode at the same time. This makes it possible to time-multiplex them. If the clock frequency can be three times the sample frequency, the hardware may consist of only one Cordic.

There are also some drawbacks: The output signal of a Cordic is larger than the input. The amplification is constant (1.647 times). The only way to compensate for this is by multiplying the outputs with 0.6073, which makes this solution slightly more costly, but since it is a multiplication with a constant, it does not need a complete multiplier. The phase meter has a range of −π . . . +π. This means that there is inevitably a jump at −π. Partly this can be solved by mapping the phase on a digital scale of −1024 . . . 1023. An 11 bit signed signal will overflow at precise the right point. However, there are some complications when averaging over a number of pixels, which leads to some extra hardware or software. The trigonometric version does not have any non-linearity and is slightly simpler in this respect.

Summary

A method is disclosed which compensates for the problem that a comb filter working on a line-locked grid cannot cope with non-standard line frequencies because cross-luminance suppression deteriorates considerably, by shifting the phase of the lines used for combing, relative to the present line. It can be proven that for deviating line and/or subcarrier frequencies, a phase shift is the best possible compensation and can be implemented relatively cheap, e.g. using either a limited number of multipliers or a few Cordic blocks. The same method can also be used to compensate for jitter in the sync and clock circuit of the receiver as long as the jitter is not excessive. An aspect of the invention is that is it possible to use the same hardware for the phase measurement and for the correction, thus reducing the cost of implementation. The result is comparable with that of a burst-locked comb filter. The extra complexity of the circuit is not very big, mainly due to the fact that the expensive hardware (multipliers or Cordics) can be shared between the measurement during the burst and the correction during active video. The Cordic implementation gives a slightly more robust impression, which is caused by the fact that the correction signal is not dependent on the burst amplitude.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

### LITERATURE

[1] Enden, Ad W. M. van den, Efficiency in multirate and complex digital signal processing, Appendix F, Waalre 2001, ISBN 90 6674 650 5
[2] Andraka, Ray, A survey of Cordic algorithms for FPGA based computers, 1998 (full text available from http://www.andraka.com/cordic.htm)

1. A method of compensating errors in comb filters in a line-locked sample domain, the method comprising:
delaying (LD1, LD2) an input video signal (CVBS) by first and second integral numbers of lines to obtain first and second delayed signals;
measuring (PM) a phase difference between at least two of said input video signal (CVBS) and said first and second delayed signals; and
correcting (PC1, PC2) a phase of said input video signal (CVBS) and a phase of said second delayed signal with respect to said first delayed signal in dependence on said phase difference.

2. A method as claimed in claim 1, wherein said phase correcting step (PC1, PC2) comprises:
multiplying a phase correction input signal (A, C) by first phase measurement signals (L, K) to obtain a first product;
Hilbert transforming (HT1, HT2) said phase correction input signal (A, C) to obtain a Hilbert transformed signal (D, E);
multiplying the Hilbert transformed signal (D, E) by second phase measurement signals (M, J) to obtain a second product; and
summing said first and second products.

3. A method as claimed in claim 1, wherein said phase difference measuring step (M) comprises:
Hilbert transforming (HT2) a phase correction input signal (C) to obtain a Hilbert transformed signal (E);
multiplying said first delayed signal (B) by said Hilbert transformed signal (E) to obtain a first product signal (G);
multiplying said first delayed signal (B) by said phase correction input signal (C) to obtain a second product signal (F);
low-pass filtering (LPF) said first and second product signals to obtain low-pass filtered signals (H, I); and
phase processing (PP) said low-pass filtered signals (H, I) to obtain phase measurement signals (J, K).

4. A comb filter in a line-locked sample domain, the comb filter comprising:
means for delaying (LD1, LD2) an input video signal (CVBS) by first and second integral numbers of lines to obtain first and second delayed signals;
means for measuring (PM) a phase difference between at least two of said input video signal (CVBS) and said first and second delayed signals; and
means for correcting (PC1, PC2) a phase of said input video signal (CVBS) and a phase of said second delayed signal with respect to said first delayed signal in dependence on said phase difference.

5. A color television apparatus comprising:
means for tuning and demodulating a television signal to obtain a video signal (CVBS);
a comb filter as claimed in claim 4 to obtain luminance and chrominance signals;
means for processing said luminance and chrominance signals to obtain display signals (R, G, B); and
means for displaying said display signals. (R, G, B).
